(19) United States
(12) Patent Application Publication
(10) Pub. No.: US 2006/0252463 A1
(43) Pub. Date: Nov. 9, 2006

(54) Mobile phones

(75) Inventors: Kuo-Hung Liao, Taichung City (TW); Cheng-Tao Wu, Tainan City (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/416,323

(22) Filed: May 3, 2006

(30) Foreign Application Priority Data
May 6, 2005 (TW) 94114699

(51) Int. Cl. H04B 1/38; H04M 1/00; H04K 3/00

(52) U.S. Cl. 455/567

(57) ABSTRACT

Mobile phones are provided. A mobile phone, switchable between a standard mode and a vibration mode, includes a main body and a movable anti-slip member. The anti-slip member connects to the main body and is movable between a first position and a second position. When the mobile phone is in standard mode, the anti-slip member is situated in the first position and hidden in the main body. When the mobile phone is switched from standard mode to vibration mode, the anti-slip member moves from the first position to the second position and protrudes from the main body.

### BACKGROUND

The invention relates in general to mobile phones and in particular to mobile phones with movable anti-slip members.

With progress of wireless communication technology, mobile phones have become popular communication equipment for people. To avoid intrusive ring tones, many mobile phones can be set to a vibration alert status.

When receiving a call in vibration alert mode, as shown in FIG. 1, the mobile phone is switched to a vibration mode and vibrates immediately. However, if not answered immediately, it may slip and drop leading to damage. Some mobile phones are provided with protruding rubber pads to prevent slipping, however, this may adversely affect the appearances of the mobile phone. Further, the rubber pads can be uncomfortable to hold.

### SUMMARY

Mobile phones are provided. An embodiment of a mobile phone switches between a standard mode and a vibration mode, and includes a main body and a movable anti-slip member. The anti-slip member connects to the main body and is movable between a first position and a second position. When the mobile phone is in standard mode, the anti-slip member is situated in the first position and hidden in the main body. When the mobile phone is switched from standard mode to vibration mode, the anti-slip member moves from the first position to the second position and protrudes from the main body.

### DESCRIPTION OF THE DRAWINGS

FIG. 1 is a perspective diagram of a conventional mobile phone;

FIG. 2 is a perspective diagram of an embodiment of a mobile phone with an anti-slip member in a first position;

FIG. 3 is a perspective diagram of an embodiment of a mobile phone with an anti-slip member in a second position;

FIG. 4 shows an embodiment of an anti-slip member situated in a first position by magnetic attraction from an electromagnet; and

FIG. 5 shows an embodiment of an anti-slip member situated in a second position by magnetic repulsion from an electromagnet.

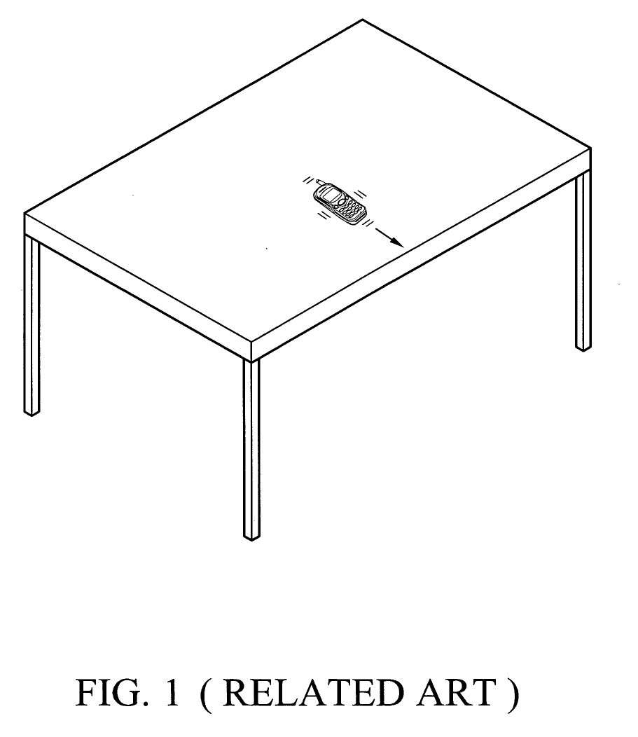

### DETAILED DESCRIPTION

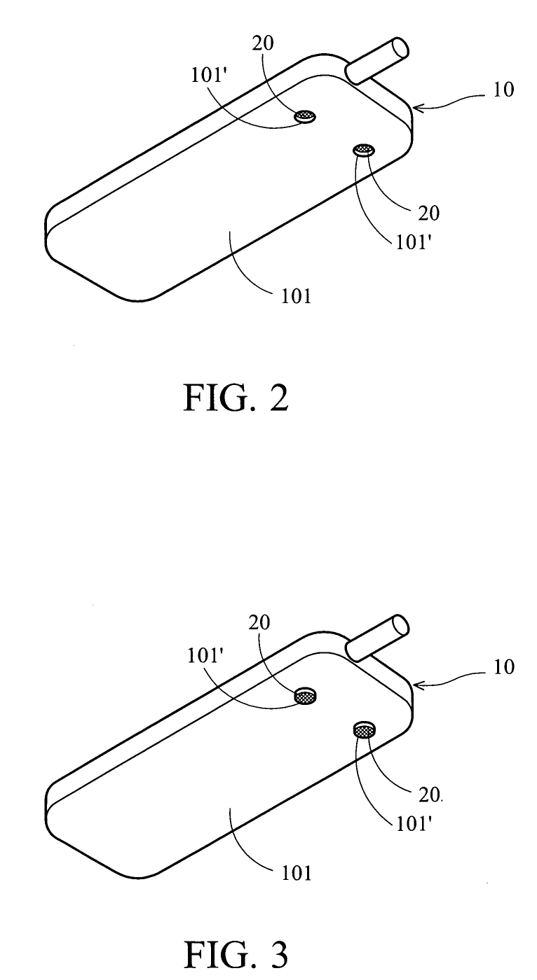

An exemplary embodiment of a mobile phone can be set to vibration alert status. In vibration alert status, the mobile phone is alternatively switched between a standard mode (when not receiving a call) and a vibration mode (when receiving a call). Referring to FIGS. 2 and 3, the mobile phone primarily comprises a main body 10 and an anti-slip member 20 movably disposed on a housing 101 of the main body 10, to prevent slipping when in vibration mode.

With respect to FIGS. 2 and 3, the anti-slip member 20 is movable between a first position and a second position. When the mobile phone is in standard mode, as shown in FIG. 2, the anti-slip member 20 is situated in the first position and hidden in the main body 10. When receiving a call, as shown in FIG. 3, the mobile phone is switched from standard mode to vibration mode, and the anti-slip member 20 is moved from the first position to the second position, protruding from the housing 101.

Since the anti-slip member 20 provides effective friction with a surface, slipping of the mobile phone is avoid when in vibration mode. When the mobile phone is in standard mode, specifically, the anti-slip member 20 is hidden in the main body 10, such that whole appearance of the mobile phone is unaffected. Moreover, in standard mode, the anti-slip member 20 is not exposed, providing comfortable usage.

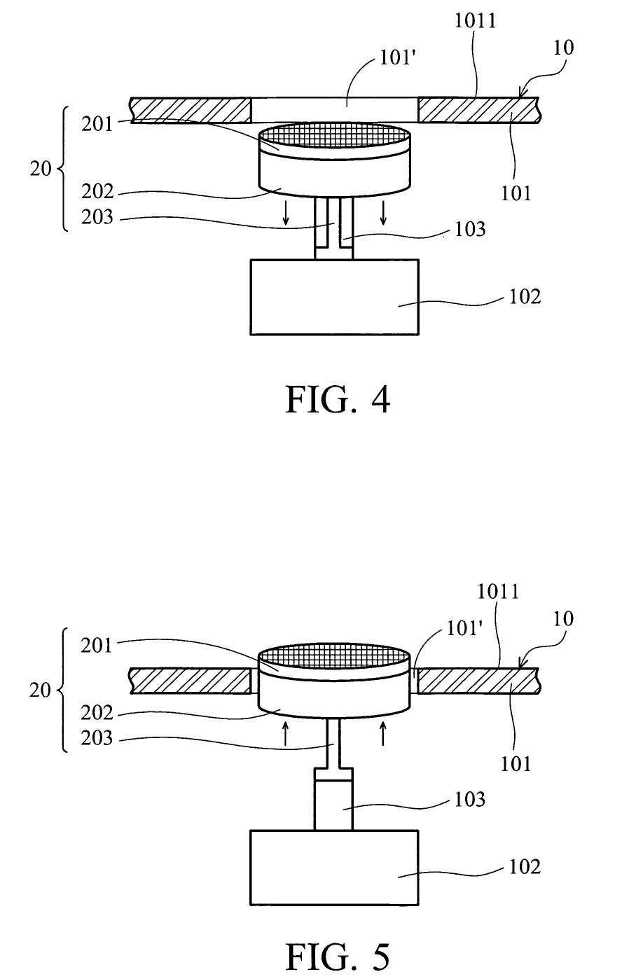

As shown in FIGS. 4 and 5, an embodiment of the anti-slip member 20 moves between a first position and a second position by magnetic force. The anti-slip member 20 comprises a permanent magnet 202, a sliding portion 203 and a frictional pad 201 adhered to the permanent magnet 202. Specifically, the sliding portion 203 is connected to the permanent magnet 202 and movable along the rail 103. In some embodiments, the frictional pad 201 comprises rubber or other materials with high frictional coefficient, and the sliding portion 203 comprises plastic material. Moreover, the mobile phone further comprises an electromagnet 102 and a rail 103 both disposed in the main body 10.

When the mobile phone is in standard mode, the permanent magnet 202 is magnetically attracted by the electromagnet 102. As the electromagnet 102 can spontaneously attract the permanent magnet 202, in some embodiments, it is not necessary to electrify the electromagnet 102. Thus, the anti-slip member 20 is drawn into the main body 10 and situated in the first position, as shown in FIG. 4.

When receiving a call, as shown in FIG. 5, the mobile phone is switched from standard mode to vibration mode, and the electromagnet 102 is electrified, applying a magnetic repulsive force to the permanent magnet 202. Hence, the anti-slip member 20 is ejected through the opening 101′ to the second position with the frictional pad 201 protruding from an outer surface 1011 of the housing 101. In some embodiments, the mobile phone may comprise a plurality of anti-slip members 20 and corresponding openings 101′, thus providing sufficient friction to avoid slipping of the mobile phone when in vibration mode.

In some embodiments, a motor (not shown) is provided in the main body 10 to move the anti-slip member 20 between the first and second positions. When the mobile phone is in standard mode, the motor drives the anti-slip member 20 to the first position, hidden in the main body 10.

Mobile phones with movable anti-slip members are provided according to the embodiments. When the mobile phone is switched to vibration mode, the anti-slip member provides sufficient friction to prevent the mobile phone from slipping. When the mobile phone is in standard mode, the anti-slip member is hidden in the main body by magnetic force or a motor, such the appearance of the mobile phone is unaffected and the phone is comfortable to use.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A mobile phone, switchable between a standard mode and a vibration mode, comprising:
a main body; and
an anti-slip member, connected to the main body and movable between a first position and a second position, wherein the anti-slip member is in the first position when the mobile phone is in the standard mode, and the anti-slip member is in the second position protruding from the main body when the mobile phone is in the vibration mode.

2. The mobile phone as claimed in claim 1, wherein the main body comprises a housing and an electromagnet disposed therein, and the anti-slip member comprises a permanent magnet and a frictional pad connected thereto, the electromagnet applying a repulsive force on the permanent magnet, compelling the anti-slip member to move from the first position to the second position to protrude from an outer surface of the main body when the mobile phone is switched from the standard mode to the vibration mode.

3. The mobile phone as claimed in claim 2, wherein the electromagnet applies an attractive force on the permanent magnet, compelling the anti-slip member to move from the second position to the first position when the mobile phone is switched from the vibration mode to the standard mode.

4. The mobile phone as claimed in claim 2, wherein the housing comprises an opening, through which the frictional pad moves to protrude from the outer surface when the anti-slip member moves from the first position to the second position.

5. The mobile phone as claimed in claim 4, wherein the mobile phone comprises a plurality of anti-slip members, and the housing comprises a plurality of openings corresponding to the anti-slip members.

6. The mobile phone as claimed in claim 2, wherein the frictional pad comprises rubber material.

7. The mobile phone as claimed in claim 2, wherein the main body further comprises a rail, and the anti-slip member further comprises a sliding portion moving along the rail when the anti-slip member moves between the first and second positions.

8. The mobile phone as claimed in claim 7, wherein the sliding portion is connected to the permanent magnet.

9. The mobile phone as claimed in claim 7, wherein the sliding portion comprises plastic material.

10. The mobile phone as claimed in claim 1, wherein the main body comprises a housing and a motor connecting the anti-slip member, and the motor drives the anti-slip member between the first and second positions.
